(19) United States
(12) Patent Application Publication
(10) Pub. No.: US 2013/0146418 A1
(43) Pub. Date: Jun. 13, 2013

(54) SORTING APPARATUS AND METHOD OF SORTING COMPONENTS

(71) Applicants: Norman Merrill PEDERSEN, Portland, OR (US); Doug J. GARCIA, Beaverton, OR (US)

(72) Inventors: Norman Merrill PEDERSEN, Portland, OR (US); Doug J. GARCIA, Beaverton, OR (US)

(73) Assignee: ELECTRO SCIENTIFIC INDUSTRIES, INC, Portland, OR (US)

(21) Appl. No.: 13/315,786

(22) Filed: Dec. 9, 2011

(51) Int. Cl. B65G 47/46

(52) U.S. Cl. 198/348

(57) ABSTRACT

A sorting apparatus can include a component carrier structured to transport a component along a travel path, a first sort bin, a second sort bin, a first transfer station structured to transfer a component from the component carrier at a first transfer position along the travel path to the first sort bin and a second transfer station structured to transfer a component from the component carrier at a second transfer position along the travel path to the second sort bin. In this embodiment, the distance between the first transfer position and the second transfer position can be less than a width of at least one of the first sort bin and the second sort bin.

### BACKGROUND

Embodiments of the present invention as exemplarily described herein relate generally to sorting apparatuses. More particularly, embodiments of the present invention relate to automated sorting apparatuses capable of efficiently transporting and sorting a component into one of a plurality of sort bins. Embodiments of the present invention also relate to methods of sorting components into sort bins.

Many components such as electronic devices are tested for electrical and optical properties during manufacturing by automated test systems. Typical automatic sorting apparatuses use precision electrical or optical properties of a device and either accept, reject or sort it into an output category depending on the measured values. For miniature devices, automatic sorting apparatuses are often designed to handle, bulk loads, where the manufacturing process creates a volume of devices that have substantially identical mechanical characteristics such as size and shape but differ in electrical or optical properties that generally fall within a range and rely on testing to sort the components into sort bins containing other components with similar characteristics. For some components, the number of groups into which a component can be sorted can be large. As the number of possible number of groups into which a component can be sorted increases, the size of the sorting apparatus can grow undesirably large, the size of the sorting apparatus can grow undesirably large at least in part due to the number of sort bins incorporated within the sorting apparatus.

### SUMMARY

According to one embodiment of the present invention, a sorting apparatus includes a component carrier structured to transport a component along a travel path, a first sort bin, a second sort bin, a first transfer station structured to transfer a component from the component carrier at a first transfer position along the travel path to the first sort bin and a second transfer station structured to transfer a component from the component carrier at a second transfer position along the travel path to the second sort bin. In this embodiment, the distance between the first transfer position and the second transfer position can be less than a width of at least one of the first sort bin and the second sort bin.

According to another embodiment of the present invention, a sorting apparatus includes a first component carrier having a first component retainer and a second component retainer. Each of the first and second component retainers can be configured to support a component and the first component carrier is configured to transport the first and second component retainers along a travel path. The sorting apparatus can also include a first sort bin, in addition to a first transfer station and a second transfer station disposed along the travel path. In this embodiment, the first transfer station can be structured to transfer a component from the first component retainer to the first sort bin and the second transfer station can be structured to transfer a component from the second component retainer to the first sort bin.

According to still another embodiment of the present invention, a method of sorting components can include transporting a first component and a second component along a travel path, transferring the first component from a first transfer position along the travel path to a first sort bin and transferring the second component from a second transfer position along the travel path to a second sort bin. In this embodiment, a distance between the first transfer position and the second transfer position can be less than a width of at least one of the first sort bin and the second sort bin.

According to yet another embodiment of the present invention, a method of sorting components can include transporting a first component and a second component along a travel path, transferring the first component from a first transfer position along the travel path to a sort bin and transferring the second component from a second transfer position along the travel path to the sort bin.

### BRIEF DESCRIPTION OF THE DRAWINGS

FIG. 1 is a schematic view of a sorting apparatus according to one embodiment of the present invention.

FIG. 2 is a side elevation view illustrating a component carrier according to one embodiment of the present invention.

FIG. 3 is a sectional view illustrating the component carrier shown in FIG. 2, taken along line III-III.

FIG. 4 is a top plan view illustrating a transfer system according to one embodiment of the present invention in relation to a plurality of sort bins and a track.

FIG. 5 is a side elevation view illustrating the transfer system shown in FIG. 4, taken along line V-V shown in FIG. 4, in relation to a component carrier disposed at a first transfer position along a travel path.

FIG. 6 is a side elevation view illustrating the transfer system shown in FIG. 4, taken along line VI-VI shown in FIG. 4, in relation to a component carrier disposed at a second transfer position along a travel path.

FIG. 7 is sectional view illustrating guide members according to one embodiment of the present invention.

### DETAILED DESCRIPTION OF THE ILLUSTRATED EMBODIMENTS

The invention is described more fully hereinafter with reference to the accompanying drawings, in which example embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that, although the terms first, second, third, etc., may be used herein to describe various elements, components, regions, sets, etc., these elements, components, regions, sets, should not be limited by these terms. These terms are only used to distinguish one element, component, region, set, etc., from another element, component, region, set, etc. Thus, a first element, component, region, set, etc., discussed below could be termed a second element, component, region, set, etc., without departing from the teachings provided herein.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

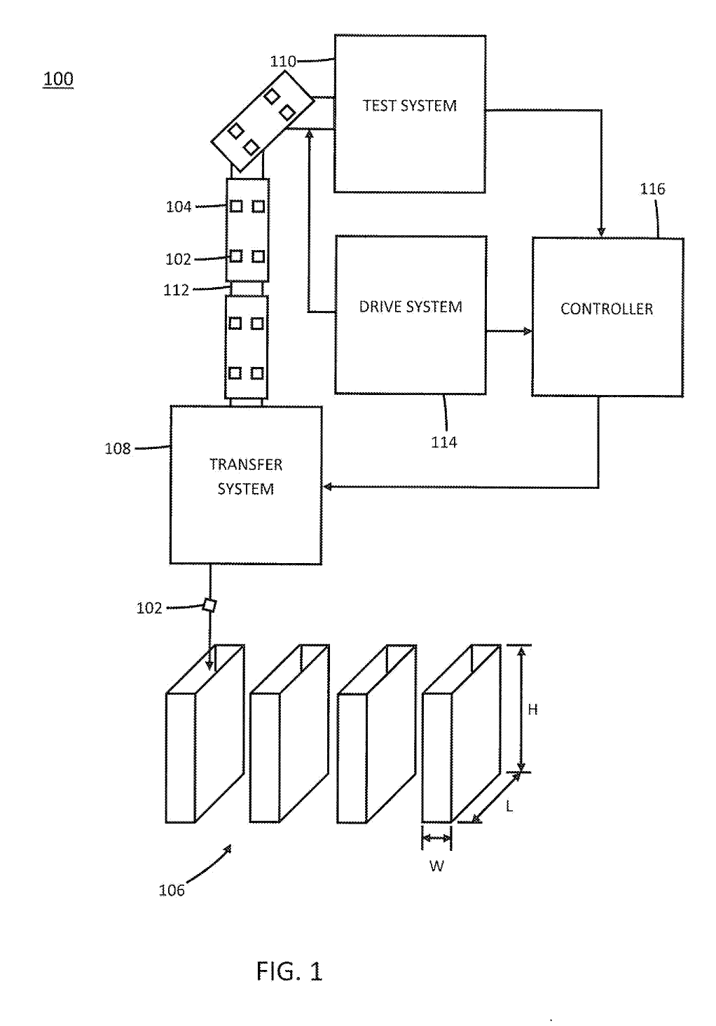

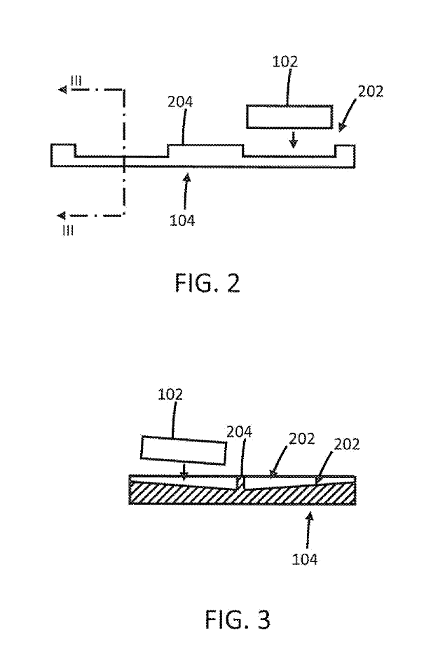

FIG. 1 is a schematic view of a sorting apparatus according to one embodiment of the present invention. FIG. 2 is a side elevation view illustrating a component carrier according to one embodiment of the present invention. FIG. 3 is a sectional view illustrating the component carrier shown in FIG. 2, taken along line III-III.

Referring to FIG. 1, a sorting apparatus, such as sorting apparatus 100 is configured to sort components 102 into one of a plurality of groups based on one or more measured characteristics of the components 102 (i.e., “component characteristics”). Examples of types of components 102 that can be sorted by the sorting apparatus 100 include capacitors (e.g., multi-layer ceramic capacitors, etc.), light-emitting diodes (LEDs), chip-scale packages (CSPs), and the like. Generally, however, components 102 to be sorted by the sorting apparatus 100 in one sorting procedure are of the same type.

As schematically illustrated, the sorting apparatus 100 includes component carriers 104 configured to transport components 102 along a travel, path, sort bins 106 configured to receive one or more components 102 and a transfer system 108 configured to transfer components 102 from the component carriers 104 to the sort bins 106. Although FIG. 1 illustrates the sorting apparatus 100 as including only three component carriers 104, it will be appreciated that the sorting apparatus 100 may include only 1, 2, 4 or any other number of component carriers 104. As will be discussed in greater detail below, each component carrier 104 can include a component retainer configured to support a component 102 as the component 102 is transported along the travel path.

Referring to FIGS. 2 and 3, a component carrier 104 can include a plurality of component retainers, such as component retainers 202, wherein each component retainer is configured to support a single component 102. Component retainers 202 of a component carrier 104 are generally positionally fixed relative to each other. In one embodiment, a component retainer 202 can be provided as a recess formed in a body 204 of the component carrier 104 and configured to receive a component 102. The length and width of sidewalls of the recess may be selected so as to prevent a component 102 received within the recess from moving undesirably as the component 102 is transported along the travel path. As exemplarily shown in FIG. 3, the floor of the recess may be inclined toward the center of the component carrier 104 to minimize the likelihood that a component 102 will fall out of the recess as the component 102 is transported along the travel path. In one embodiment, the component carrier 102 can be provided as the track section (or “section of track”) exemplarily described in U.S. patent application Ser. No. 12/732,002 (hereinafter “the '002 application”) or as the carrier exemplarily described in U.S. patent application Ser. No. 13/163,516 (hereinafter “the '516 application”) or in U.S. patent application Ser. No. 13/163,504 (hereinafter “the '504 application”), all of which are incorporated by reference in their entireties.

Referring back to FIG. 1, each of the sort bins 106 include side walls or panels and an interconnecting lower floor or panel that, together, define an interior space within which one or more components 102 can be received. The upper portion of each sort bin 106 can be open to define an entrance through which components 102 can be enter into the interior space. The interior space of a sort bin 106 can be generally characterized as having a length (L), a width (W), and a height (H). Typically, dimensions of the interior space defined by a sort bin 106 are much larger than the thickness of the side and lower panels. Accordingly as used herein, the length of a sort bin 106 will refer to the length of the interior space defined by the sort bin 106. Likewise, the width and height of a sort bin 106 will refer to the width and height, respectively, of the interior space defined by the sort bin 106. The length of a sort bin 106 will generally be longer than the width of the sort bin 106, unless the length and the width are equal. In addition, the height of the sort bin 106 will generally be greater than the width of the sort bin 106, but may be greater than, less than or equal to the length of the sort bin 106. Although the sort bins 106 are schematically illustrated as having a uniform length along the width and height, a uniform width along the length and height, and a uniform height along the length and width, it will be appreciated that the length, width and height of one or more of the sort bins 106 may be varied in any manner desired.

In one embodiment, each sort bin 106 can have a width that is greater than the largest dimension of a component 102 to be sorted into the sort bin 106 to reduce the likelihood that a component 102 will become lodged across the interior space of a sort bin 106 (a phenomenon also known as “bridging” or “window locking”). For example, a sort bin 106 can have a width that is at least three times greater than the largest dimension of a component 102 to be sorted into the sort bin 106. In another example, a sort bin 106 can have a width that is at least four times greater than the largest dimension of a component 102 to be sorted into the bin sort 106. In yet another example, a sort bin 106 can have a width that is at least eight times greater than the largest dimension of a component 102 to be sorted into the bin sort 106. Other factors that can influence the width, W, of a sort bin 106 include, for example, the fragility of the component 102, the presence or absence of vibration, gravity, etc. The largest dimension of a component 102 that can be sorted into a sort bin 106 can, for example, be in a range of between about 2.0 mm and about 10 mm. In another example, the largest dimension of a component 102 that can be sorted into a sort bin 106 can be in a range between about 3.5 mm and about 7 mm. In one embodiment, a sort bin 106 can have a width that is in a range of about 24 mm to about 40 mm. In other embodiments, however, a sort bin 106 can have a width that is less than about 24 mm or greater than about 40 mm. Although FIG. 1 illustrates the sorting apparatus 100 as including only four sort bins 106, it will be appreciated that the sorting apparatus 100 may include any number of sort bins 106. For example, the sorting apparatus 100 may include 8, 16, 32, 64, 128, 256, 512, or any other number of sort bins 106. It will be appreciated that the number of sort bins 106 to be included within the sorting apparatus 100, and the width of each sort bin 106 can be adjusted to increase the number of groups into which a component 102 can be sorted while also reducing the likelihood of bridging or window locking. Adjusting the number and width of sort bins 106 of the sorting apparatus 100 in this manner can also help to prevent the sorting apparatus from occupying an undesirably large footprint in a facility.

The sorting apparatus 100 can further include a test system 110 configured to measure one or more characteristics of the components 102 and, for each component 102, generate measurement data representing the value of a component characteristic for a component 102 that has been measured by the test system 110. Examples of component characteristics include physical dimensions of a component 102, electrical characteristics (e.g., charge time, leakage current, forward operating voltage, electrical current draw, resistance value, capacitance, etc.) of a component 102, optical characteristics (e.g., luminance flux, luminous intensity, spectral light output, dominant wavelength output, peak wavelength output, correlated color temperature, color rendering index, etc.) of a component 102. In one embodiment, the test system 110 can be provided as any of the test stations exemplarily described in the '002 application, the '516 application or the '504 application. Although FIG. 1 illustrates the sorting apparatus 100 as including only one test system 110, it will be appreciated that the sorting apparatus 100 may include any number of test systems 110. For example, the sorting apparatus 100 may include two test systems 110.

The sorting apparatus 100 can further include a track 112 configured to guide a movement of the component carriers 104 such that the components 102 are transported along the travel path (e.g., from the test system 110 to the transfer system 108). In the illustrated embodiment, track 112 is moveable along the travel path and the component carriers 104 are fixed to the track 112. As a result, the component carriers 104 can move along the travel path with the track 112. In another embodiment, however, the track 112 is fixed and the component carriers 104 are moveable with respect to the track 112 along the travel path. In one embodiment, the track 112 can be provided as the track exemplarily described in the '002 application or as the conveyor exemplarily described in the '516 application or the '504 application.

The sorting apparatus 100 can further include a drive system 114 configured to move the component carriers 104 such that the components 102 are transported along the travel path. In one embodiment, the drive system 114 is configured to incrementally move the component carriers 104 such that the components 102 are incrementally moved (i.e., indexed) along the travel path by an incremental distance, Di. For example, the drive system 114 can include a motor coupled to the track 112 to incrementally move the track 112 along the travel path by the incremental distance, thereby causing the component carriers 104 to move along the travel path by the incremental distance. Incremental movement involves periods of motion separated by a period of stillness. Generally, the incremental distance, Di, can be determined first by the maximum dimension of the component 102 to be sorted into a bin sort 106 and, second by the width, W, of a sort bin 106. In one embodiment, the incremental distance, Di, is greater than the maximum dimension of the component 102 to be sorted into a bin sort 106 and less than the width, W, of a sort bin 106. In one embodiment, the incremental distance, Di, is half the width, W, of a sort bin 106. In other embodiments, the incremental distance, Di, can be less than or equal to the maximum dimension of the component 102 to be sorted into a bin sort 106. In one embodiment, the incremental distance, Di, can be in a range of about 12 mm to about 20 mm. In another embodiment, the incremental distance, Di, is 12 mm. The drive system 114 can generate drive data indicating that the drive system 114 has moved the track 112 or component carriers 104 along the travel path by the incremental distance, Di.

The sorting apparatus 100 can further include a controller 116 coupled to the transfer system 108, the test system 110 and the drive system 114. In one embodiment, the controller 116 is configured to control operations of the transfer system 108 based upon the characteristics of a component 102 measured at the test system 110. For example, the controller 116 can be coupled to an output of the test system 110 and receive measurement data from the test system 110. The controller 116 can also be coupled to an output of the test system 110 and receive drive data from the drive system 114. Based on the received measurement data and drive data, the controller 116 can control the transfer system 108 to transfer a component 102 having a measured component characteristic from a component carrier 104 to an appropriate sort bin 106. As used herein, an “appropriate” sort bin 106 can refer to a sort bin 106 that either contains or is otherwise assigned to receive components having a component characteristic that is the same or similar to the measured component characteristic of the component 102 to be transferred from the component carrier 104.

The controller 116 can include operating logic (not shown) that defines various control, management and/or regulation functions, and may be in the form of dedicated hardware, such as a hardwired state machine, a processor executing programming instructions, and/or a different form as would occur to those skilled in the art. Operating logic may include digital circuitry, analog circuitry, or a hybrid combination of both of these types. In one embodiment, the operating logic includes a programmable microcontroller or microprocessor, that can include one or more processing units arranged to execute software and/or firmware stored in memory (not shown). Memory can include one or more types including semiconductor, magnetic, and/or optical varieties, and/or may be of a volatile and/or nonvolatile variety. In one embodiment, memory stores programming instructions of operating logic. Alternatively or additionally, memory may store data that is manipulated by operating logic. In one arrangement, operating logic and memory are included in a controller/processor form of operating logic that manages and controls operational aspects of the transfer system 108, although in other arrangements they may be separate. In yet another embodiment, the controller 116 can be provided as any of the controllers exemplarily described in the '002 application, the '516 application, or the '504 application.

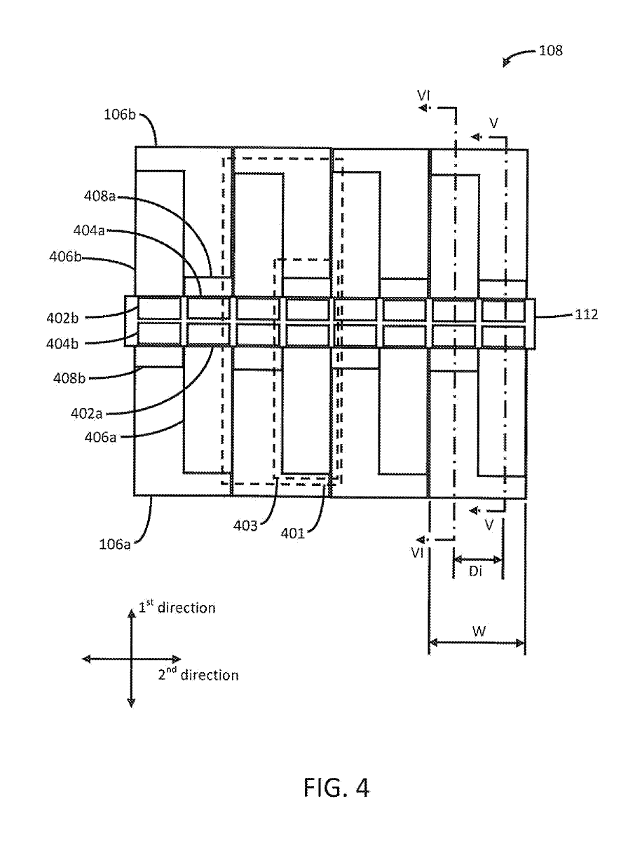

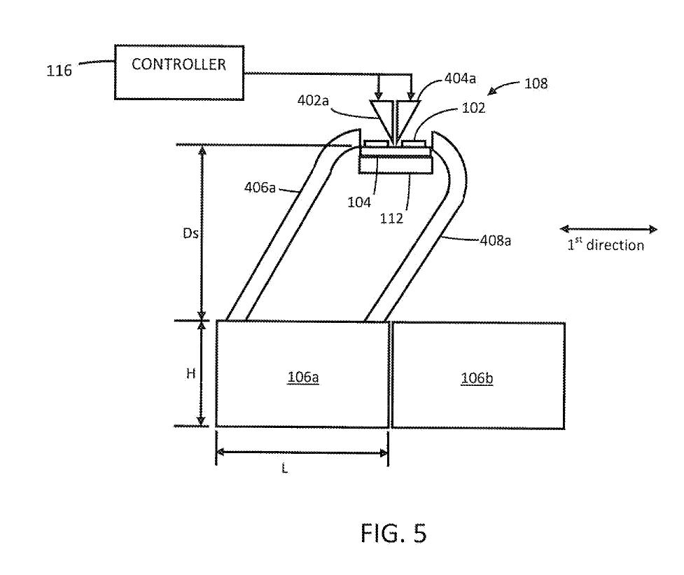

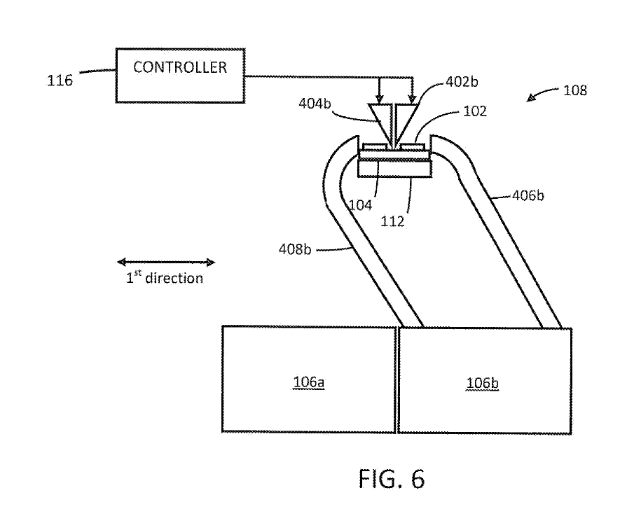

FIG. 4 is a top plan view illustrating a transfer system according to one embodiment of the present invention in relation to a plurality of sort bins and a track. FIG. 5 is a side elevation view illustrating the transfer system shown in FIG. 4, taken along line V-V shown in FIG. 4, in relation to a component carrier disposed at a first transfer position along a travel path. FIG. 6 is a side elevation view illustrating the transfer system shown in FIG. 4, taken along line VI-VI shown in FIG. 4, in relation to a component carrier disposed at a second transfer position along a travel path.

FIG. 4 illustrates a plurality of sets of sort bins, wherein each set of sort bins includes a first sort bin 106a and a second sort bin 106b (generically, the sort bins 106 shown in FIG. 1). In other embodiments, however, any set of sort bins 106 may include more than two sort bins 106, or may include only one sort bin 106. FIG. 4 also illustrates a portion of the track 112 which, as mentioned above, defines the travel path along which components 102 can be transported by component carriers 104. The portion of the track 112 shown in FIG. 4 defines a travel path extending along the arrow labeled 2^{nd} direction. Across sets of sort bins 106, the first sort bins 106a are aligned with respect to each other along the travel path (e.g., in the 2^{nd} direction) and the second sort bins 106b are aligned with respect to each other along the travel path (e.g., in the 2^{nd} direction). However within each set of sort bins 106, the first and second sort bins 106a and 106b are aligned with respect to each other in a direction that extends away from the travel path (e.g., in the 1^{st} direction). Although the 1^{st} direction is illustrated as being perpendicular to the 2^{nd} direction, it will be appreciated that the 1^{st} direction can be oriented at any desired angle relative to the 2^{nd} direction. It will also be appreciated that the sort bins 106 may be disposed in any desired arrangement. For example, the sort bins 106 may be arranged in a single level or may be arranged in multiple levels where sort bins 106 in one level are vertically stacked over sort bins 106 in another level. In embodiments where the sort bins are arranged in multiple levels, guide tubes or the like may be provided to guide components past an upper level of sort bins 106 to a lower level of sort bins 106.

Referring to FIGS. 4 to 6, the transfer system 108 includes a plurality of sets 401 of transfer stations arranged along the travel path, wherein each transfer station within a set 401 is generally configured to transfer a component 102 from the component carrier 104 to a sort bin 106 in a corresponding set of sort bins 106. Generally, each transfer station includes an actuator (e.g., one of actuators 402a, 404a, 402b, or 404b) configured to remove a component 102 from the component carrier 104 and a corresponding guide member (e.g., one of guide members 406a, 408a, 406b, or 408b, respectively) configured to receive a component 102 removed from the component carrier 104 and guide the received component to a sort bin 106. In other embodiments, however, the guide member can be omitted from a transfer station and the actuator of such a transfer station can be configured to eject a component 102 removed from a component carrier 104 directly into a sort bin 106. Within sets 401 of transfer stations, the actuators 402a and 404b are aligned with respect to each other along the travel path (e.g., in the 2^{nd} direction), as are the actuators 404a and 402b. Similarly, across sets 401 of transfer stations, the actuators 402a and 404b are aligned with respect to each other along the travel path, as are the actuators 404a and 402b. It will be appreciated, however, that the actuators may be disposed in any desired arrangement.

Each transfer station is configured to transfer a component 102 from the component carrier 104 at a transfer position along the travel path to a sort bin 106 in a corresponding set of sort bins 106. For example, as shown in FIGS. 4 and 5, when a component carrier 104 is arranged at a first transfer position along the travel path (e.g., as indicated by line V-V in FIG. 4), a first transfer station formed by the actuator 402a and guide member 406a is configured to transfer a component 102 from the component carrier 104 to first sort bin 106a. Likewise, a second transfer station formed by the actuator 404a and guide member 408a is configured to transfer a component 102 from the component carrier 104 to the same first sort bin 106a. In the illustrated embodiment, the guide members 406a and 408a are configured to guide a component 102 into the same first sort bin 106a, but from different locations at the entrance of the first sort bin 106a. As a result, the first sort bin 106a can be uniformly filled with components 102. Similarly, as shown in FIGS. 4 and 6, when a component carrier 104 is arranged at a second transfer position along the travel path (e.g., as indicated by line VI-VI in FIG. 4), a third transfer station formed by the actuator 402b and guide member 406b is configured to transfer a component 102 from the component carrier 104 to second sort bin 106b. Likewise, a fourth transfer station formed by the actuator 404b and guide member 408b is configured to transfer a component 102 from the component carrier 104 to the same second sort bin 106b. The guide members 406b and 408b are configured to guide a component 102 into the same second sort bin 106b, but from different locations at the entrance of the sort bin 106b. As a result, the second sort bin 106b can be uniformly filled with components 102.

As shown in FIG. 4, the distance between the first transfer position and the second transfer position is equal to the incremental distance, Di. Thus, although not explicitly labeled, a plurality of transfer positions extend along the travel path, such that the distance between adjacent transfer positions along the travel path is equal to the incremental distance, Di. It will be appreciated, however, that the distance between any adjacent transfer positions along the travel path can be greater than, equal to, or less than the incremental distance, Di. It will also be appreciated that different pairs of transfer positions that are adjacent to each other along the travel path can be separated from each other by a uniform or non-uniform distance.

As exemplarily illustrated in FIGS. 4 to 6, each set 401 of transfer stations can include a plurality of sub-sets 403 of transfer stations, wherein each transfer station within a sub-set 403 is generally configured to transfer a component 102 from the component carrier 104 to the same sort bin 106. Thus, FIG. 5 illustrates one sub-set 403 of transfer stations including the first transfer station (formed by the actuator 402a and guide member 406a) and the second transfer station (formed by the actuator 404a and guide member 408a). Similarly, FIG. 6 illustrates another sub-set 403 of transfer stations including a third transfer station formed by the actuator 402b and guide member 406b and a fourth transfer station formed by the actuator 404b and guide member 408b. Within sub-sets 403 of transfer stations, actuators 402a and 404a are aligned with respect to each other in a direction that extends away from the travel path (e.g., in the 1^{st} direction), as are the actuators 404b and 402b.

In the illustrated embodiment, the number of sets 401 of transfer stations corresponds to, and is equal to, the number of sets of sort bins 106. In other embodiments, however, the number of sets 401 of transfer stations may not correspond to, or can be greater than or less than, the number of sets of sort bins 106. In the illustrated embodiment, the number of sub-sets 403 of transfer stations within a set 401 of transfer stations corresponds to, and is equal to, the number of sort bins 106 within a set of sort bins 106. In other embodiments, however, the number of sub-sets 403 of transfer stations within a set 401 of transfer stations may not correspond to, or can be greater than or less than, the number of sort bins 106 within a set of sort bins 106.

Any of the actuators 402a, 402b, 404a or 404b of any transfer station may be provided as an electrical motor, a pneumatic actuator, a hydraulic actuator, a linear actuator, a piezoelectric actuator, an electroactive polymer, or the like or a combination thereof. An actuator of any transfer station may, for example, be provided as the eject block exemplarily described in the '002 application. Any of the guide members 406a, 406b, 408a or 408b may be provided as any suitable guide member (e.g., a tube, a conduit, a duct, a hose, or the like or a combination thereof).

Referring particularly to FIGS. 5 and 6, each actuator is generally disposed operably proximate to (or adjacent to) the track 112 such that, when a component carrier 104 transports a component 102 to a transfer position along the travel path (e.g., the first transfer position as shown in FIG. 5 or the second transfer position as shown in FIG. 6), the actuator can remove the component 102 from the component carrier 104 (e.g., upon receiving a control signal from the controller 116). Each guide member is generally disposed operably proximate to (or adjacent to) the track 112 to receive a component 102 removed from the component carrier 104 and guide the received component 102 to a sort bin 106. In the illustrated embodiment, the actuator of a transfer station is configured to remove a component 102 from the component carrier 104 by launching it on a trajectory into the guide member of the transfer station. The guide member, in turn, is configured to guide the launched component 102 toward a sort bin 106 as the component is pulled downward under the influence of gravity.

In the embodiment illustrated in FIGS. 5 and 6, the track 112 is arranged over the sort bins 106 and kept in place over the sort bins by any suitable mounting structure (not shown). In other embodiments, however, the track 112 can be arranged beside or below some or all of the sort bins 106. Although FIGS. 5 and 6 illustrate the transfer stations as overlapping the first sort bin 106a and the second sort bin 106b, it will be appreciated that any transfer station may overlap only one sort bin 106 (e.g., the first sort bin 106a or the second sort bin 106b) or none of the sort bins 106. In one embodiment, the sort apparatus 100 may include a platform (not shown) configured to support the sort bins 106 and ensure that the sort bins 106 are properly aligned with the transfer system 108. For example, the platform may include bin-engaging features (e.g., pins, detents, channels, etc.) configured to engage the sort bins 106 to minimize or eliminate relative movement amount the sort bins 106. In another example, the platform may be configured to engage with a platform engaging feature of the aforementioned mounting structure.

By providing the transfer system 108 as exemplarily described above, the distance that a component carrier 104 travels to transport a component 102 to be sorted into any sort bin 106 can be reduced, thereby helping to increase the number of groups into which a component 102 can be sorted while also helping to prevent the sorting apparatus 100 from occupying an undesirably large footprint in a facility.

It will be appreciated that the configuration of the guide members (e.g., of guide members 406a, 408a, 406b and 408b) can depend on many factors such as the manner in which the component 102 is removed from the component carrier 104 by an actuator, the separation distance (Ds) between the component 102 and the entrance of a sort bin 106, the aforementioned dimensions of the sort bin 106, the location of the track 112 relative to a sort bin 106, or the like or a combination thereof. In the illustrated embodiment, each of the guide members is provided as a tube that is substantially rigid such that one end of the tube cannot move significantly (e.g., more than about 5 mm) relative to the other end of the tube without breaking or otherwise becoming undesirably damaged. In other embodiments, however, the tube may be flexible. The tubes of the guide members may be connected together (e.g., so that they can move together) or may be disconnected (e.g., so that one tube is independently moveable).

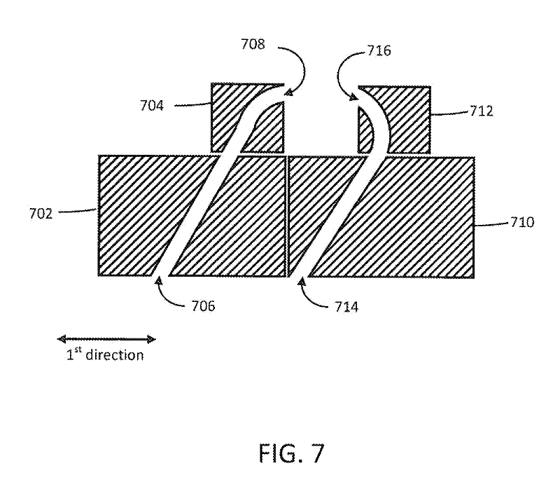

In the illustrated embodiment, the tube of each of the guide members includes a material (e.g., an anti-static polymeric material) that has been formed from a single hose-like structure. In other embodiments, however, the tube of each of the guide members can be formed from a multi-piece structure. For example, and with reference to FIG. 7, the tube of a guide member such as guide member 406a or 406b can be formed by disposing tube block 702 adjacent to tube block 704 such that the interiors of channels 706 and 708 communicate with each other. Similarly, the tube of a guide member such as guide member 408a or 408b can be formed by disposing tube block 710 adjacent to tube block 712 such that the interiors of channels 714 and 716 communicate with each other. In one embodiment, any of the tube blocks 702, 704, 710 and 712 may be formed from a monolithic piece or may be formed by coupling multiple pieces together.

In one embodiment, the tube blocks 702 and 704 can be detachably coupled together or can be integrally formed with one another. Similarly, the tube blocks 710 and 712 can be detachably coupled together or can be integrally formed with one another. Accordingly, a pair of tube blocks 702 and 704 or 710 and 712 can be used to form the guide member of a transfer station. In one embodiment, the tube blocks 702 and 710 can be detachably coupled together or can be integrally formed with one another. In one embodiment, any tube block can include more than one channel such that a pair of tube blocks 702 and 704 or 710 and 712 can be used to form the guide members for sub-sets 403 of transfer stations that are adjacent to each other (e.g., in the 2^{nd} direction shown in FIG. 4) within the same set 401 of transfer stations. In another embodiment, any tube block can include more than one channel such that a pair of tube blocks 702 and 704 or 710 and 712 can be used to form the guide members for sub-sets 403 of transfer stations that are adjacent to each other (e.g., in the 2^{nd} direction shown in FIG. 4) across the sets 401 of transfer stations that are adjacent to each other (e.g., in the 2^{nd} direction shown in FIG. 4).

The foregoing is illustrative of embodiments of the invention and is not to be construed as limiting thereof. Although a few example embodiments of the invention have been described, those skilled in the art will readily appreciate that many modifications are possible in the example embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific example embodiments of the invention disclosed, and that modifications to the disclosed example embodiments, as well as other embodiments, are intended to be included within the scope of the appended claims. The invention is defined by the following claims, with equivalents of the claims to be included therein.

What is claimed is:

1. A sorting apparatus, comprising:
a component carrier structured to transport a component along a travel path;
a first sort bin and a second sort bin;
a first transfer station structured to transfer a component from the component carrier at a first transfer position along the travel path to the first sort bin; and
a second transfer station structured to transfer a component from the component carrier at a second transfer position along the travel path to the second sort bin,
wherein a distance between the first transfer position and the second transfer position is less than a width of at least one of the first sort bin and the second sort bin.

2. The sorting apparatus of claim 1, wherein the first sort bin is aligned with the second sort bin along a first direction and the first transfer station is aligned with the second transfer station along a second direction.

3. The sorting apparatus of claim 2, wherein the first direction is perpendicular to the second direction.

4. The sorting apparatus of claim 1, wherein the first transfer station and the second transfer station overlap at least a, portion of at least one of the first sort bin and the second sort bin.

5. The sorting apparatus of claim 1, wherein the distance between the first transfer position and the second transfer position is half the width of at least one of the first sort bin and the second sort bin.

6. The sorting apparatus of claim 1, wherein the distance between the first transfer position and the second transfer position is about 20 mm.

7. The sorting apparatus of claim 1, wherein the width of at least one of the first sort bin and the second sort bin is greater than about 40 mm.

8. The sorting apparatus of claim 1, further comprising:
a third sort bin; and
a third transfer station structured to transfer a component from the component carrier at a third transfer position along the travel path to the third sort bin,
wherein a distance between the third transfer position and the second transfer position is less than a width of the at least one of the first sort bin, the second sort bin and the third sort bin in the second direction.

9. The sort apparatus of 8, wherein a distance between the third transfer position and the first transfer position is less than or equal to the width of the at least one of the first sort bin, the second sort bin and the third sort bin.

10. The sorting apparatus of claim 8, further comprising:
a fourth sort bin; and
a fourth transfer station structured to transfer a component from the component carrier at a fourth transfer position along the travel path to the fourth sort bin,
wherein a distance, between the fourth transfer position and the third transfer position is less than a width of the at least one of the first sort bin, the second sort bin, the third sort bin and the fourth sort bin.

11. The sort apparatus of claim 10, wherein a distance between the fourth transfer position and the first transfer position is greater than the width of the at least one of the first sort bin, the second sort bin, the third sort bin and the fourth sort bin.

12. The sorting apparatus of claim 1, wherein at least one of the first transfer station and the second transfer station includes an actuator configured to remove the component from the component carrier.

13. The sorting apparatus of claim 12, wherein at least one of the first transfer station and the second transfer station further includes a guide member configured to guide the removed component to a sort bin.

14. The sorting apparatus of claim 13, wherein the first transfer station and the second transfer station each include a guide member.

15. The sorting apparatus of claim 14, wherein the guide member of the first transfer station and the guide member the second transfer station are connected together.

16. A sorting apparatus, comprising:
a first component carrier having a first component retainer and a second component retainer, wherein each of the first and second component retainers is configured to support a component, wherein the first component carrier is configured to transport the first and second component retainers along a travel path;
a first sort bin; and
a first transfer station and a second transfer station disposed along the travel path, wherein the first transfer station is structured to transfer a component from the first component retainer to the first sort bin and wherein the second transfer station is structured to transfer a component from the second component retainer to the first sort bin.

17. The sorting apparatus of claim 16, wherein the first component retainer and the second component retainer are positionally fixed relative to each other.

18. The sorting apparatus of claim 16, further comprising a second component carrier moveable relative to the first component carrier.

19. The sorting apparatus of claim 16, further comprising:
a second sort bin; and
a third transfer station and a fourth transfer station disposed along the travel path, wherein the third transfer station is structured to transfer a component from the first component retainer to the second sort bin and wherein the fourth transfer station is structured to transfer a component from the second component retainer to the second sort bin.

20. The sorting apparatus of claim 19, wherein
the second sort bin is adjacent to the first sort bin along a first direction; and
at least one of the third and fourth transfer stations is adjacent to at least one of the first and second transfer stations along a second direction different from the first direction.

21. The sorting apparatus of claim 20, further comprising a drive system coupled to the first component carrier, wherein the drive system is configured to move the first component carrier such that the first and second component retainers are incrementally moveable along the travel path by an incremental distance.

22. The sorting apparatus of claim 21, wherein the incremental distance is less than a width of at least one of the first sort bin and the second sort bin along the second direction.

23. A method of sorting components, the method comprising:
transporting a first component and a second component along a travel path;
transferring the first component from a first transfer position along the travel path to a first sort bin; and
transferring the second component from a second transfer position along the travel path to a second sort bin,
wherein a distance between the first transfer position and the second transfer position is less than a width of at least one of the first sort bin and the second sort bin.

24. A method of sorting components, the method comprising:
transporting a first component and a second component along a travel path;
transferring the first component from a first transfer position along the travel path to a sort bin; and
transferring the second component from a second transfer position along the travel path to the sort bin.
